(19) United States
(12) Patent Application Publication
(10) Pub. No.: US 2024/0065124 A1
(43) Pub. Date: Feb. 29, 2024

(54) RECONFIGURABLE GROUND DRIVEN SOIL CONDITIONING WHEEL

(71) Applicants: Isiah Brandt, Cedar Falls, IA (US); Brent Alan Malmstrom, Geneseo, IL (US)

(72) Inventors: Isiah Daniel Brandt, Cedar Falls, IA (US); Brent Alan Malmstrom, Geneseo, IL (US)

(73) Assignee: Black Eagle Ag Solutions Inc., Farragut, IL (US)

(21) Appl. No.: 18/238,485

(22) Filed: Aug. 26, 2023

Related U.S. Application Data
(60) Provisional application No. 63/401,534, filed on Aug. 26, 2022.

(51) Int. Cl. A01B 15/16; A01B 49/02; A01B 49/04; A01B 49/06; A01C 21/00

(52) U.S. Cl. CPC A01B 15/16; A01B 49/027; A01B 49/04; A01B 49/06; A01C 21/002

(57) ABSTRACT

A strip till finishing system includes a pair of wheels, each outer circumference including a plurality of equidistantly spaced openings for engagement; at least two attachment plates coupled to each of the pair of wheels, each attachment plate having a circumference matching the outer circumference, each attachment plate coupled to the outer circumferences via a plurality of attachment means configured on each attachment plate to align with the plurality of equidistantly spaced openings, and a plurality of ground-engaging finger elements coupled to each pair of attachment plate over a 360 degree arc, the plurality of ground-engaging finger elements directed outwardly from each wheel to enable ground engagement.

### CROSS-REFERENCE TO RELATED APPLICATIONS

The present application is a non-provisional filing of, and claims benefit under 35 U.S.C. § 119(e) from, U.S. Provisional Patent Application Ser. No. 63/401,534, entitled “RECONFIGURABLE GROUND DRIVEN SOIL CONDITIONING WHEEL,” filed Aug. 26, 2022, which is hereby incorporated by reference in its entirety.

### FIELD OF THE DISCLOSURE

The present disclosure generally relates agricultural strip tillage soil conditioning devices, and in particular, ground driven and ground engaging strip finishers.

### BACKGROUND

Current methods of finishing strips consist of ground driven wheels which consist of wheels with round bars protruding from the wheel at an angle. The best these devices can do is some firming and very little crumbling of clods as the interaction between the soil and the round bars does little to condition the soil. Rolling baskets are another technology used with either flat bars placed perpendicular to the basket or chains in place of the bars. These basket designs can provide more conditioning but only work well when soils are extremely dry. Wet soil causes baskets and chains to become plugged full of dirt and become a useless solid packed wheel. These prior technologies do not allow for the combination of crushing, tilling, sizing, mixing, redirecting and firming of the soil in the strip. Further, and adaptable system for different soil conditions is needed, which currently is unavailable due to the fixed nature of current soil conditioning configurations. Such fixed configurations allow no adaptability to reconfigure the ground engaging apparatus to meet wet and challenging soil conditions or a particularly desired structure of the finished strip.

Accordingly, what is needed is a soil conditioner operable in different soil conditions that is configurable to achieve a required finished strip structure.

### SUMMARY

One or more embodiments are directed to a soil conditioning apparatus and method including a wheel having an outer circumference with a plurality of equidistantly spaced openings for engagement, at least two attachment plates having a circumference matching the outer circumference, the at least two attachment plates coupled to the outer circumference via a plurality of attachment means configured on each attachment plate to align with the plurality of equidistantly spaced openings, and a plurality of ground-engaging finger elements coupled to each attachment plate over a 360 degree arc, the plurality of ground-engaging finger elements directed outwardly from the wheel to enable ground engagement.

In one or more embodiments, each of the plurality of ground-engaging finger elements have a square cross section and are formed with each attachment plate.

In one or more embodiments, the plurality of finger elements extend horizontally from a vertical plane of the wheel from between 0 to 10 degrees of incline.

In one or more embodiments, each of the plurality of ground-engaging finger elements have a swept angle of 30 to 90 degrees from a vertical plane of each attachment plate.

In one or more embodiments, each of the plurality of ground-engaging finger elements extend beyond the outer circumference forming a larger circumference.

In one or more embodiments, the plurality of ground-engaging finger elements is reconfigurable to enable a plurality of orientations by altering the relationship between the attachment plates with respect to the wheel through clockwise or counterclockwise rotation and/or inversion.

In one or more embodiments, the plurality of ground-engaging finger elements are interlaced.

In one or more embodiments, the plurality of ground-engaging finger elements of each attachment plate create a mirror image.

In one or more embodiments, the plurality of ground-engaging finger elements in an offset orientation via rotation of the attachment plates according to the equidistantly spaced openings.

In one or more embodiments, the plurality of ground-engaging finger elements are in an aligned orientation via the attachment plates.

Another embodiment is directed to a soil conditioning apparatus including a wheel having an outer circumference with a plurality of equidistantly spaced openings for engagement, at least two attachment plates having a circumference matching the outer circumference, each attachment plate coupled to the outer circumference via a plurality of attachment means configured on each attachment plate to align with the plurality of equidistantly spaced openings, and a plurality of ground-engaging finger elements coupled to each attachment plate over a 360 degree arc, the plurality of ground-engaging finger elements directed outwardly from the wheel to enable ground engagement such that each attachment plate is reconfigurable to align the plurality of ground-engaging finger elements in either an offset, mirror, aligned or interlaced configuration.

One or more embodiments are directed to a strip till finishing system including a pair of wheels, each wheel having an outer circumference including a plurality of equidistantly spaced openings for engagement, and at least two attachment plates coupled to each respective wheel, each attachment plate having a circumference matching the outer circumference of the respective wheel, each respective attachment plate coupled to the outer circumferences via a plurality of attachment means configured on each attachment plate to align with the plurality of equidistantly spaced openings, and a plurality of ground-engaging finger elements coupled to attachment plate over a 360 degree arc, the plurality of ground-engaging finger elements directed outwardly from each wheel to enable ground engagement, an axle coupled to the pair of wheels, an arm appendage coupled the axle and a chassis, the arm appendage to provide downward pressure, and a spring coupled to the arm appendage at a compound angle of orientation to a strip of ground and the forward motion of a strip till unit, the spring providing a transfer of forward momentum to the strip till unit applying an energy of force towards soil clods and underlying disturbed soil to alter one or more of air pockets, clods, and surface soil, and to move loose soil generally towards a center of the strip of ground.

In one or more embodiments, the strip till finishing system further includes one or more delivery tubes coupled to the chassis configured to dispense surface applied herbicides, seed and fertilizer.

In one or more embodiments, the strip till finishing system further includes one or more containment blades, one or more center cutter blades, one or more side scoring blades, and one or more row cleaner blades coupled to the chassis.

### BRIEF DESCRIPTION OF THE DRAWINGS

A detailed description is set forth below with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates a strip tillage unit with soil conditioning wheels in accordance with one or more embodiments.

FIG. 2 illustrates a side view of a strip tillage unit with soil conditioning wheels in accordance with one or more embodiments.

FIG. 3A illustrates a perspective view of an assembled pair of soil conditioning wheels on a strip tillage unit illustrating interlaced ground-engaging finger elements in accordance with one or more embodiments.

FIG. 3B illustrates a soil condition wheel with spokes and without attachment plates in accordance with one or more embodiments.

FIG. 3C illustrates a soil condition wheel without spokes and without attachment plates in accordance with one or more embodiments.

FIG. 3D illustrates a pair of soil conditioning wheels without spokes attached to a pivoting arm and an axle in accordance with one or more embodiments.

FIG. 4 illustrates a pair of attachment plates with interlaced ground-engaging finger elements for a soil conditioning wheel in accordance with one or more embodiments.

FIG. 5. Illustrates a side view of a pair of attachment plates with interlaced ground-engaging finger elements for a soil conditioning wheel in accordance with one or more embodiments.

FIG. 6 illustrates an assembled pair of soil conditioning wheels with interlaced ground-engaging finger elements in accordance with one or more embodiments.

FIG. 7 illustrates a pair of attachment plates with mirrored ground-engaging finger elements for a soil conditioning wheel in accordance with one or more embodiments.

FIG. 8 illustrates a side view of a pair of attachment plates with mirrored ground-engaging finger elements for a soil conditioning wheel in accordance with one or more embodiments.

FIG. 9 illustrates a perspective view of an assembled pair conditioning wheels with mirrored ground-engaging finger elements in accordance with one or more embodiments.

FIG. 10 illustrates a pair of attachment plates with offset and mirrored ground-engaging finger elements for a soil conditioning wheel in accordance with one or more embodiments.

FIG. 11 illustrates a side view of a pair of attachment plates with offset and mirrored ground-engaging finger elements for a soil conditioning wheel in accordance with one or more embodiments.

FIG. 12 illustrates a perspective view of an assembled pair of soil conditioning wheels with offset and mirrored ground-engaging finger elements in accordance with one or more embodiments.

FIG. 13 illustrates a pair of attachment plates with offset and mirrored 90 degree bent ground-engaging finger elements for a soil conditioning wheel in accordance with one or more embodiments.

FIG. 14 illustrates a side view of a pair of attachment plates with offset and mirrored 90 degree bent ground-engaging finger elements in accordance with one or more embodiments.

FIG. 15 illustrates an assembled pair of soil conditioning wheels with offset and mirrored 90 degree bent ground-engaging finger elements in accordance with one or more embodiments.

FIG. 16 illustrates a pair of attachment plates with interlaced 90 degree bent ground-engaging finger elements in accordance with one or more embodiments.

FIG. 17 illustrates a side view of a pair of attachment plates with interlaced 90 degree bent ground-engaging finger elements in accordance with one or more embodiments.

FIG. 18 illustrates an assembled pair of soil conditioning wheels with attachment plates with interlaced 90 degree bent ground-engaging finger elements in accordance with one or more embodiments.

FIG. 19 illustrates a pair of attachment plates with mirrored 90 degree bent ground-engaging finger elements in accordance with one or more embodiments.

FIG. 20 illustrates a side view of a pair of attachment plates with mirrored 90 degree bent ground-engaging finger elements in accordance with one or more embodiments.

FIG. 21 illustrates an assembled pair of soil conditioning wheels with attachment plates with mirrored 90 degree bent ground-engaging finger elements in accordance with one or more embodiments.

FIG. 22 illustrates a pair of attachment plates with aligned ground-engaging finger elements in accordance with one or more embodiments.

FIG. 23 illustrates a side view pair of attachment plates with aligned ground-engaging finger elements in accordance with one or more embodiments.

FIG. 24 illustrates an assembled pair of soil conditioning wheels with attachment plates with aligned ground-engaging finger elements in accordance with one or more embodiments.

FIG. 25 illustrates a side view of an 180-degree arc attachment plate with 35 degree bent ground-engaging finger elements in accordance with one or more embodiments.

FIG. 26 illustrates a 180-degree arc attachment plate with 35 degree bent ground-engaging finger elements in accordance with one or more embodiments.

FIG. 27 illustrates a side view of a 180-degree arc attachment plate with a 45-degree bent ground-engaging finger elements in accordance with one or more embodiments.

FIG. 28 illustrates a 180-degree arc attachment plate with a 45-degree bent ground-engaging finger elements in accordance with one or more embodiments.

FIG. 29 illustrates a side view of a 180-degree arc attachment plate with 90 degree bent ground-engaging finger elements in accordance with one or more embodiments.

FIG. 30 illustrates a 180-degree arc attachment plate with 90 degree bent ground-engaging finger elements in accordance with one or more embodiments.

### DETAILED DESCRIPTION

### Overview

In terms of a general overview, this disclosure is generally directed to systems and methods for reconfigurable ground driven soil conditioning.

Strip tillage is the mechanical method of clearing the residue and disturbing a strip of soil from 4 to 10 inches wide but leaving the soil and residue between the strips undisturbed. Operational speeds range from 4 mph to over 10 mph depending on horsepower requirements per row and the horsepower of the tractor pulling the strip tillage unit. Fertilizer, such as phosphorus, potash, ammonia, liquid nitrogen and some micro-nutrients can be applied in the strips at depths of 4 to 10 inches deep.

A crop being planted may be planted directly on the center of the strip with the help of GPS guidance. The proximity of the fertilizer to the seedling allows for an increase in fertilizer uptake by the plants as the fertilizer is concentrated in a zone easily reachable by the roots of the plant. Closer proximities of fertilizer enable decreasing total field application rates of fertilizer. As a strip is created, such as with a shank that fractures and uplifts the soil, containment blades capture the fractured and uplifted soil and funnel it into a strip. The soil has been loosened and made black by the removal of the residue in the strip and the tillage. Uplifting and fracturing of the soil adds air space to the soil thereby leaving a mound of soil that is higher than the static plain of existing ground. Leaving a mound of higher soil is desirable in climates that have colder springs. Creating the darker soil and higher mound facilitates warming and drying of the soil in the spring so that planting can take place sooner.

The last process in creating a strip is the conditioning of the lifted and fractured soil. Conducting strip tillage in the fall is the preferred time frame. Typically, soils are dry and the freeze/thaw cycle in northern climates facilitates the fracturing and breakup of large clods into smaller soil aggregates that often result from the lifting and fracturing of the soil.

Although a freeze/thaw cycle can condition dirt in the strips, the strips can still be very uneven in the spring. Planting accuracy highly depends on a smooth, consistent surface for the planter to operate properly. A smooth, consistent surface also maximizes the consistent placement of seeds at a desired depth in the soil.

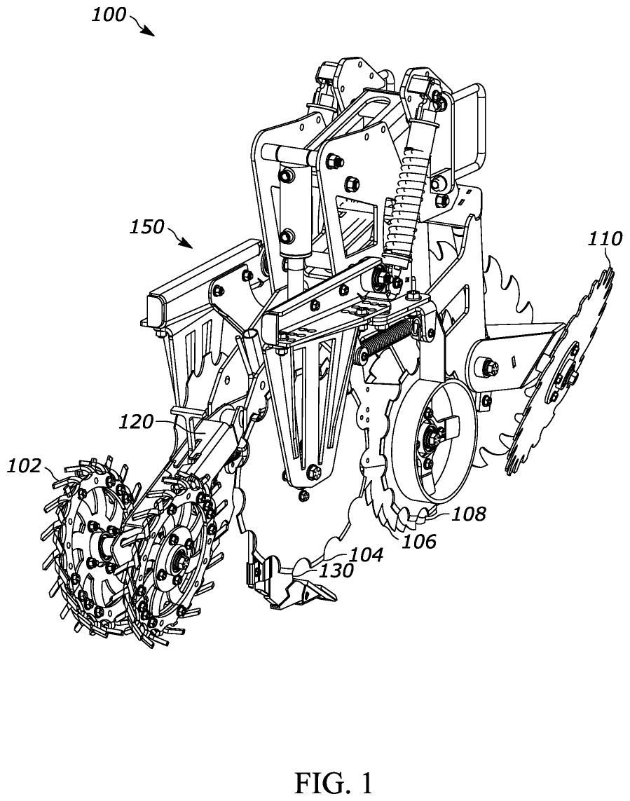

Referring now to FIG. 1, a strip-till unit 100 illustrates soil conditioning wheels 102 that provide reconfigurable attachment plates that enable an operator to meet the changing demands of soil conditions throughout the window of field operations to consistently firm the strip to minimize air pockets. Air pockets are undesirable because they can later collapse and create an uneven surface. The reconfigurable conditioning wheels 102 operate to aggressively break up clods and provide a mixing of the disturbed soil on the surface of the strip as well as moving soil towards the center of the mound. The raised mound elevation is maintained, and the surface soil of the mound is conditioned, clods are crumbled, and the soil is aerated to facilitate drying in wetter soils thereby resulting in the proper seedbed characteristics. Thus, the reconfigurable conditioning wheels 102 benefit soil in the spring as well as the fall due to the conditioned nature of the soil in the strip and minimizing the effects of wetter soils at the time of the strip tillage pass.

FIG. 1 illustrates a perspective view of a strip-till unit 100 with attached ground driven conditioning wheels 102 coupled to a chassis 150 with attached containment blades 104, center cutter blades 106, side scoring blades 108, and row cleaner blades 110. Conditioning wheels 102 are coupled to the chassis via a pivoting arm 120. Below containment blades 104, shank 130 is coupled to chassis 150 for delivery of fertilizer, seed, and other products.

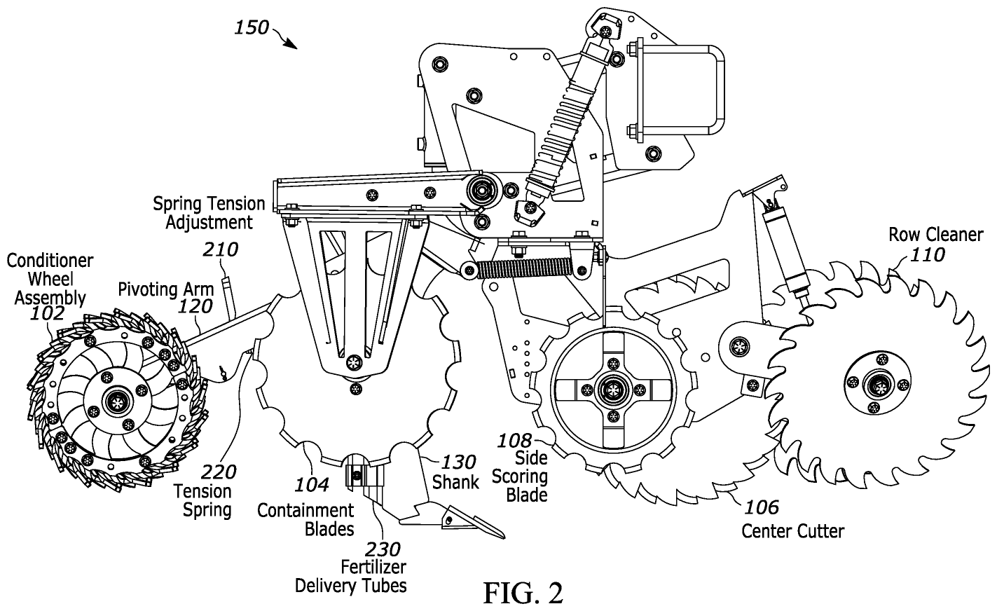

FIG. 2 illustrates a side view of strip-till unit 100 that more particularly illustrates the reconfigurable conditioner wheel 102 coupled to pivoting arm 120. As shown, pivoting arm 120 may include a spring tension adjustment 210 and spring 220 coupled to the strip-till unit chassis 150. FIG. 2 also illustrates fertilizer deliver tubes 230 coupled to shank 130. FIG. 2 further shows a different perspective of containment blades 104, center cutter 106, side scoring blades 108 and row cleaner blades 110. As shown, row cleaner blades 100 are oriented to sweep away residue with the teeth oriented to release the residue from the teeth when strip-till unit 100 is in forward motion. In one or more embodiments, the teeth of row cleaner blades act as depth control to prevent aggressive soil digging.

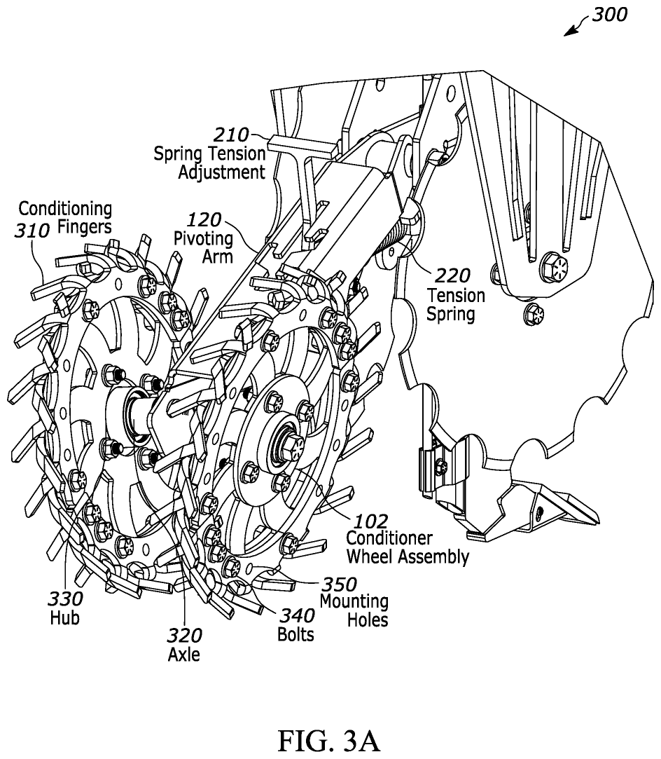

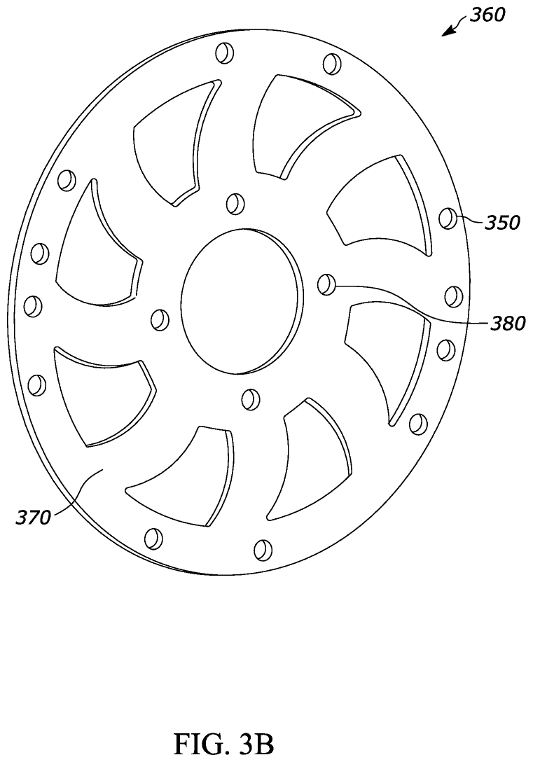

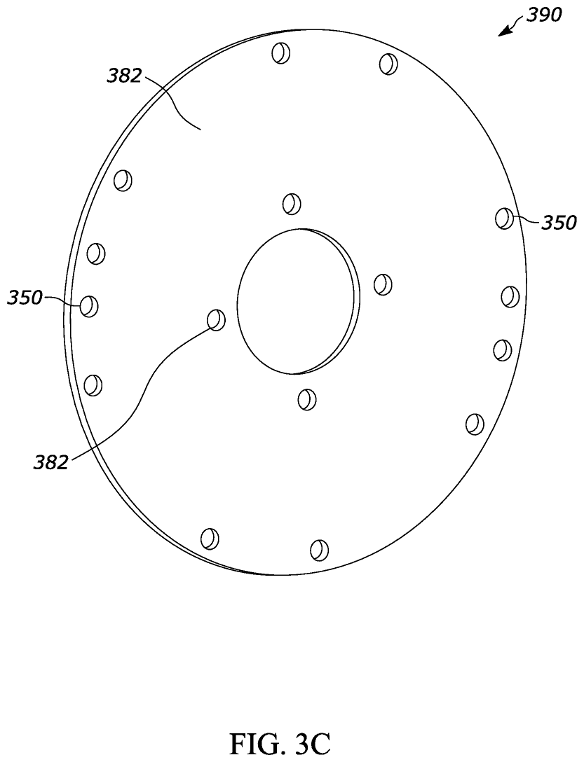

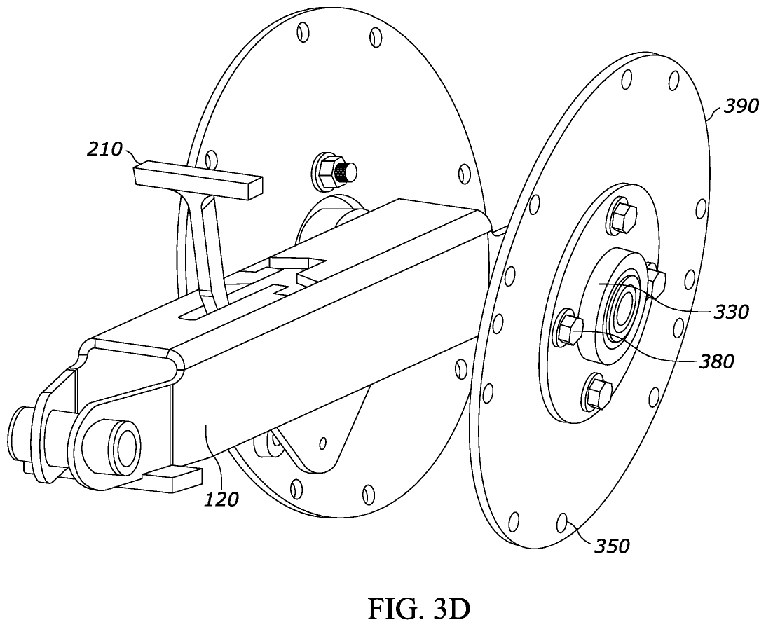

FIG. 3A illustrates a view of a portion of strip-till unit 300. The view illustrates a pair of assembled conditioner wheels, conditioner wheel assembly 102, in accordance with an embodiment. As shown, conditioner wheel assembly 102 may include two component wheels, each having a diameter made of metal or other durable material. Each wheel includes attachment plates with conditioning finger elements 310, an axle 320, hub 330, and bolts 340 secured within a plurality of mounting holes 350. Conditioner wheel assembly 102 is secured to chassis 150 via pivoting arm 120, which is controlled via spring tension adjustment 210 and tension spring 220.

Referring now to FIGS. 3B, 3C and 3D, embodiments of the conditioner wheel without attachment plates are illustrated as wheel 360 and wheel 390. Each wheel 360 and 390 maintains its shape and structure and may be ¼ inches thick to ½ inches thick and affixed to hub 330 shown in FIG. 3A, which operates around axle 320. As shown, wheel 360 has spokes 370 and wheel 390 has a solid inner area 382. The diameter of each wheel 360 and 390 may be from 10 inches to 14 inches in diameter and with a circumference including a series of equidistantly spaced mounting holes 350 for engaging one or more sections of ground-engaging finger elements with matching equidistant holes disposed on an attachment plate. FIGS. 3A-3D illustrate hub mounting holes 380 for mounting bolts or other attachment means to attach each wheel 360 and 390 to chassis 150. As shown in FIG. 3D, two solid wheels 290 are attached to a pivot arm 120 with a tension spring adjustment 210 to enable connection to a chassis 150. FIG. 3D illustrates how hub mounting holes 380 enables attachment to hub 330. Mounting holes 350 enable attachment plates with conditioning fingers to be attached to the perimeter of each wheel 390.

Each wheel assembly 102 described above, as shown in FIGS. 3A and 3D, are mounted in pairs at the back of the strip till unit on pivoting arm 120 which can pivot up and down. Spring pressure from tension spring 220 is added to pivoting arm 120 to keep the arm from bouncing and therefore keep the wheels 102 engaged with the soil. The wheels 102 are mounted at a compound angle to facilitate engaging the soil in the same arc as the created mound of soil and at an angle to funnel dirt towards the center of the mound in operation. The finger elements 310 are a square shape as to create an abrupt angular edge in which to strike the soil, firming and fracturing as it does and also helping to propel the wheel in forward motion to avoid slippage. The swept angle of the finger to the plane of the wheel acts to dig at and disturb the surface of the strip and funnel dirt towards the center of the mound. In motion, the wheels fracture clods, till the surface of the strip, firm the underlying soil and facilitate the drying of wet soils by aeration. The level of aggressive action of the conditioning wheel assembly 102 is speed sensitive and with increased ground speed the conditioning wheel assembly 102 become more aggressive. The angles and space between the wheels can be adjusted for narrow or wide strips and for aggressive tillage.

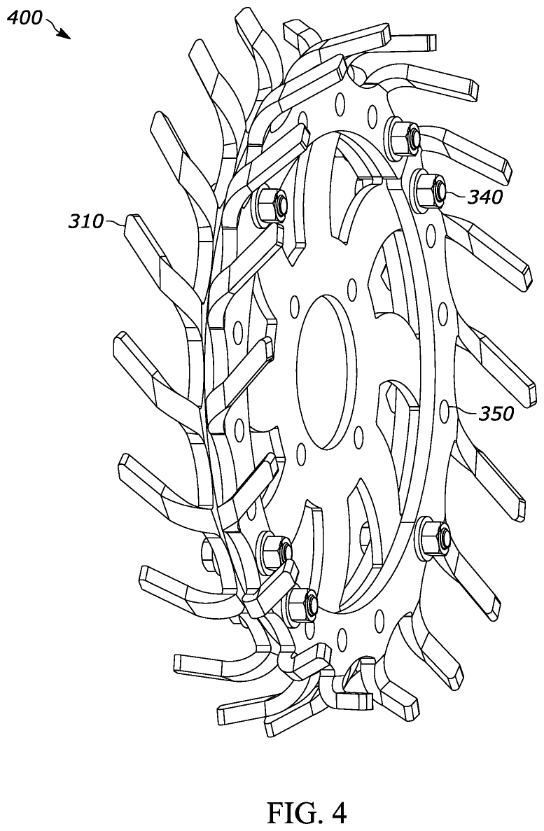

Referring to FIG. 4, a view of two attachment plates secured to a wheel 400 illustrates mounting bolts 340, mounting holes 350, and conditioning finger elements 310. As shown, each attachment plate of the sections is attached by mounting bolts 340 or other removable attachment device to the outer circumference of both sides of the wheel. FIG. 4 illustrates two 360-degree sections to match the circumference of the associated wheel are attached, one for each side of the wheel with a standard attachment side being the side opposite the conditioning finger elements. As explained in more detail below, one of skill in the art will appreciate that the attachment plates may be less than a 360-degree arc as long as other attachment plates are added to the circumference to complete the 360-degree arc about the wheel.

FIG. 4 illustrates conditioning finger elements on each plate that are “interlaced” such that each wheel on a conditioner wheel assembly 102 has finger elements that interlace with finger elements from an opposing attachment plate. In one embodiment, as shown in FIG. 4, the conditioning finger elements horizontally intersect the vertical plane of the wheel in a compound angle with each finger element and are swept back at 45 degrees and bent away from a vertical plane of the wheel up to 90 degrees.

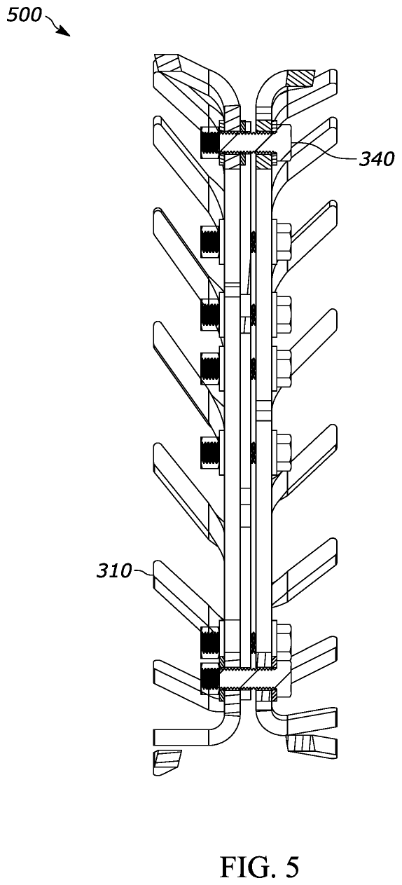

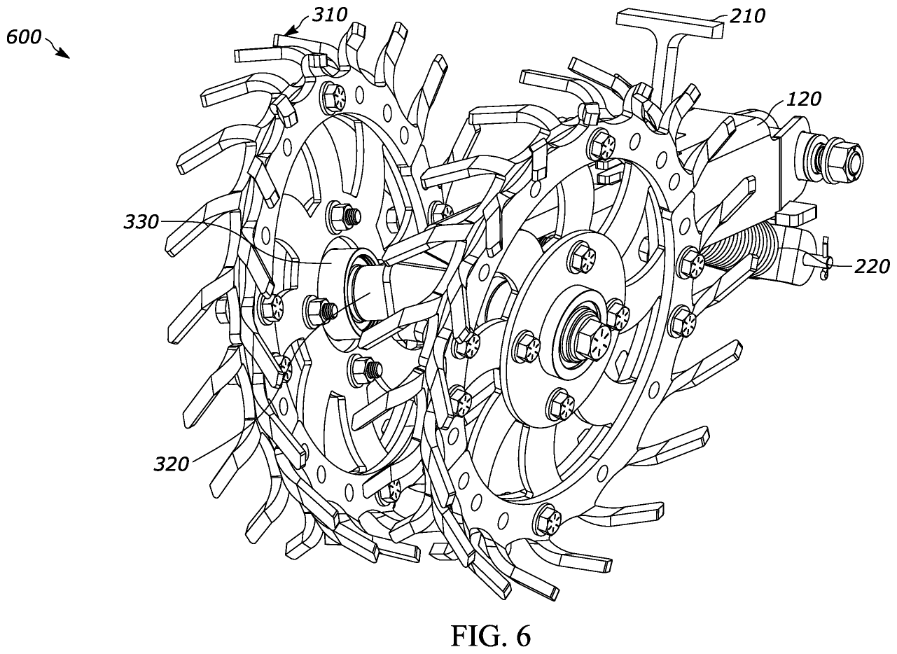

Referring to FIG. 5, a side view 500 of the wheel assembly illustrated in FIG. 4 with the same configuration of the conditioning finger elements 310 to illustrate a closer view of bolts 340, and mounting holes 350. As shown, two attachment plates are coupled to a center portion. FIG. 6 shows the same wheel assemblies 600 attached to pivoting arm 120 with spring tension adjustment 210 and spring 220 to illustrate how the wheel assembly attaches to axle 320 and hub 330.

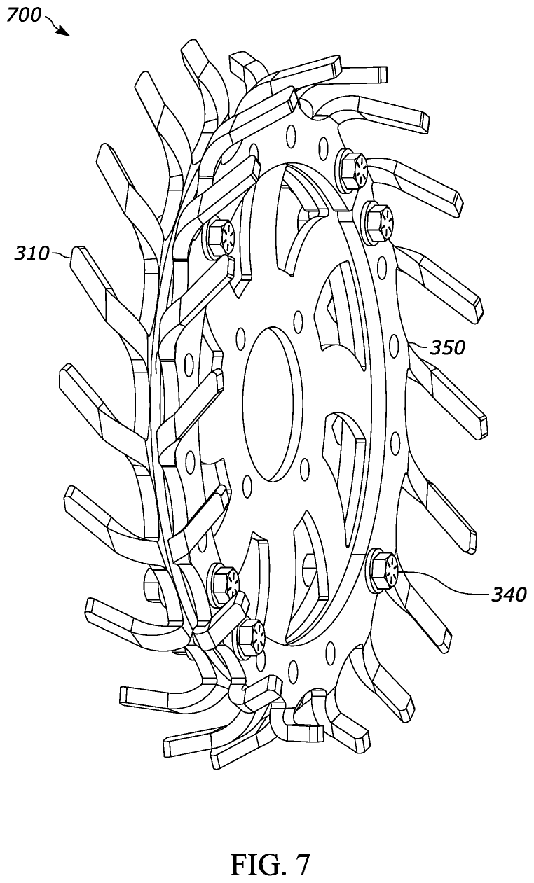

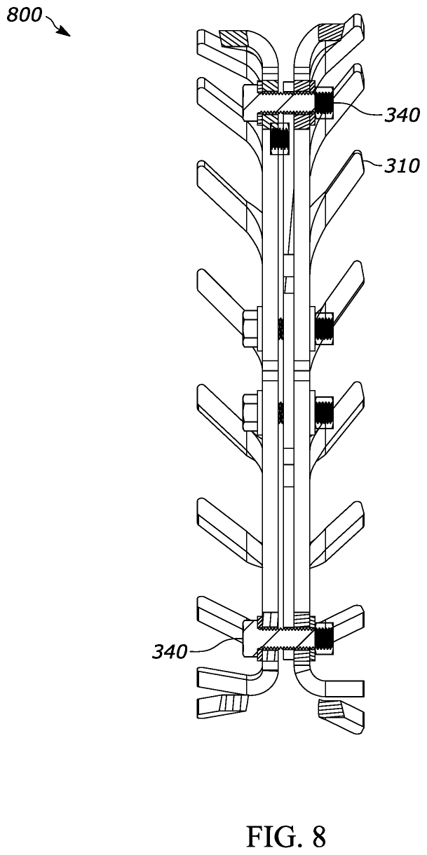

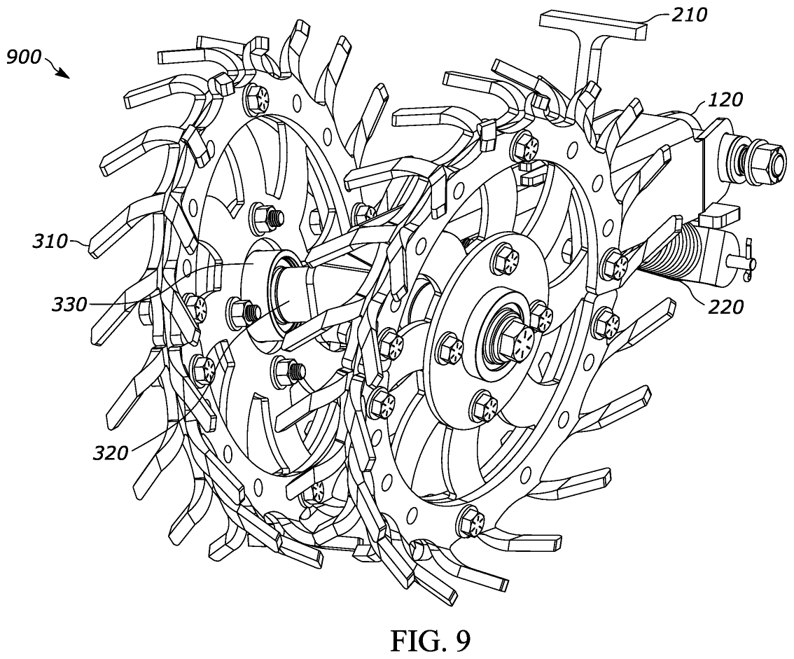

Referring to FIG. 7, another embodiment is directed to the same attachment plates flipped over and rotated to create a mirrored version of the conditioning finger elements 310. As shown, mirrored embodiment 700 shows two attachment plates with bolts 340 and mounting holes 350. As shown, the conditioning finger elements 310 are swept back 45 degrees and bent away from a vertical plane of the wheel at up to 90 degrees. FIG. 8 illustrates side view 800 with the same configuration as FIG. 7 to show bolts 340 and conditioning finger elements 310. FIG. 9 illustrates a mirrored full wheel assembly 900 of the same configuration as FIGS. 7 and 8 to illustrate pivoting arm 120, spring tension adjustment 210 and spring 220 to illustrate how wheel assembly 900 attaches to axle 320 and hub 330.

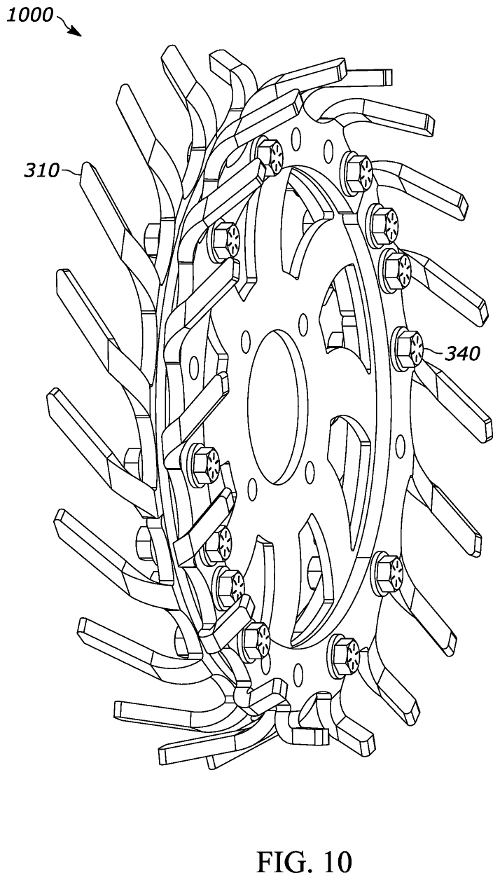

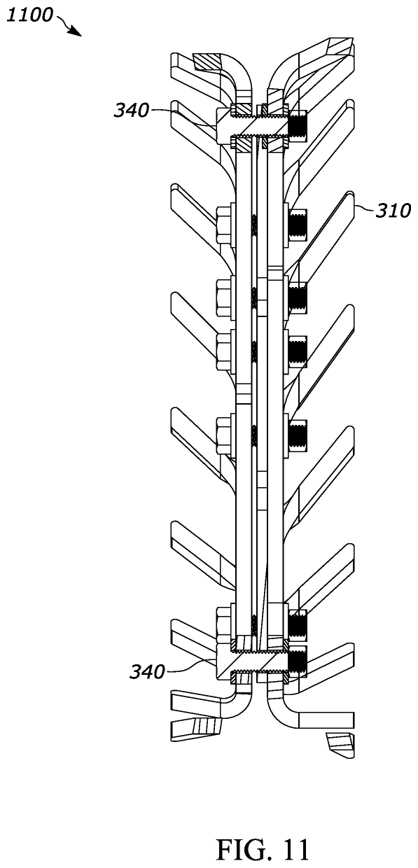

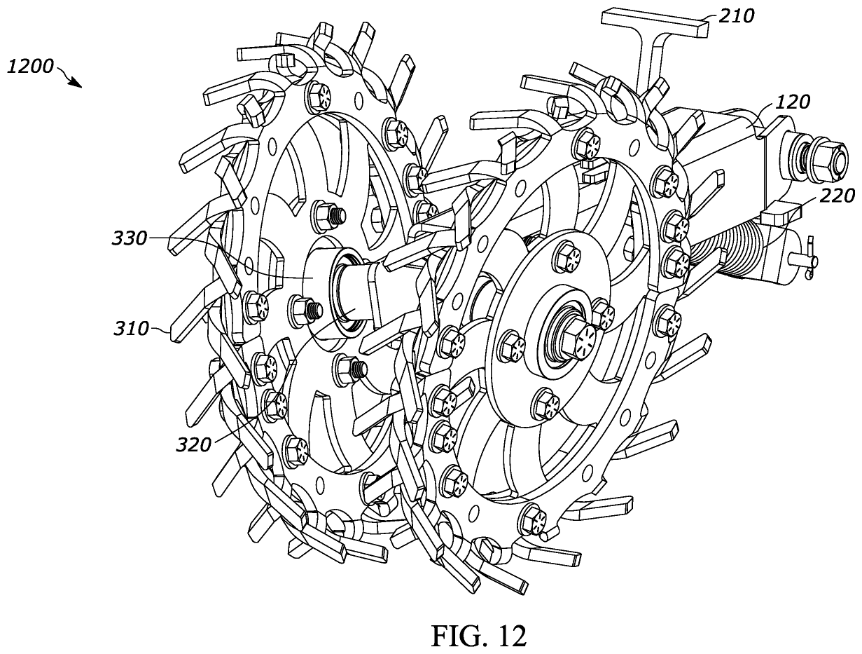

Referring to FIG. 10, the same attachment plates may be reconfigured by using different mounting holes. As shown, bolts 340 secure attachment plates shown in view 1000 to enable shifting to provide the mirrored configuration with an offset. Conditioning finger elements 310 thus are shifted instead of exactly opposite one another. Soil conditions requiring more intense conditioning would benefit from such an offset configuration. FIG. 11 illustrates as side view 1100 of the same configuration shown in FIG. 10 to illustrate bolts 340 and a side view of conditioning finger elements 310. FIG. 12 illustrates full assembly 1200 of the mirrored and offset configuration shown in FIGS. 10 and 11 to illustrate pivoting arm 120, spring tension adjustment 210 and spring 220 to illustrate how wheel assembly 1200 attaches to axle 320 and hub 330.

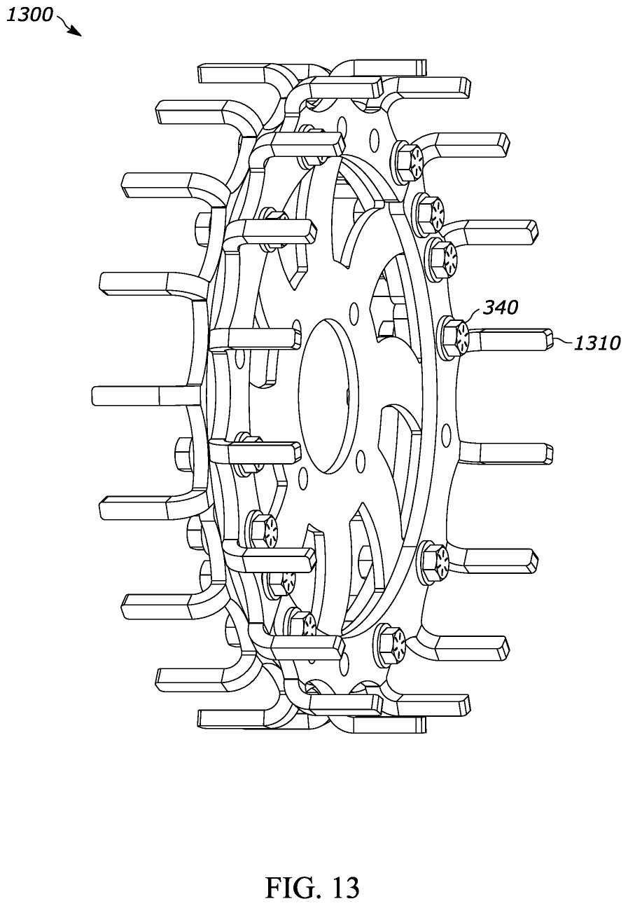

Referring to FIG. 13, wheel 1300 illustrates another embodiment with conditioning finger elements that are altered to provide mirrored, offset and 90 degree bent conditioning finger elements 1310 and bolts 340. As shown, finger elements 1310, are bent at a 90 degree angle to the plane of the wheel.

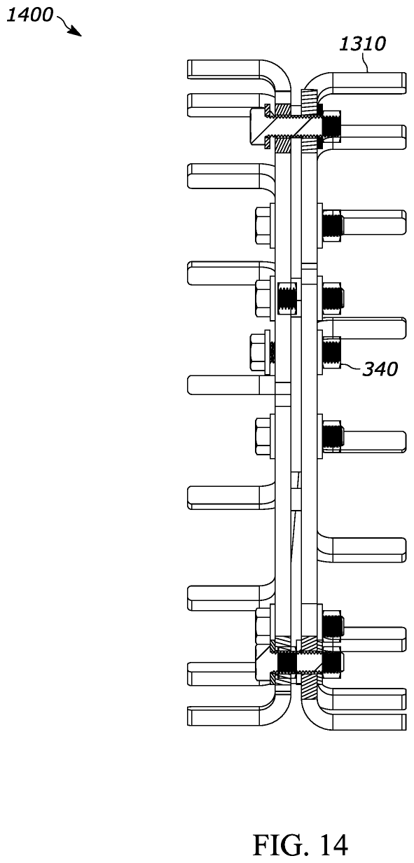

Referring now to FIG. 14, a side view of the configuration shown in FIG. 13 illustrates bolts 340 and conditioning finger elements 1310. As shown, attachment plates are coupled to a center wheel via bolts 340. As one of skill in the art will appreciate other attachment means are possible.

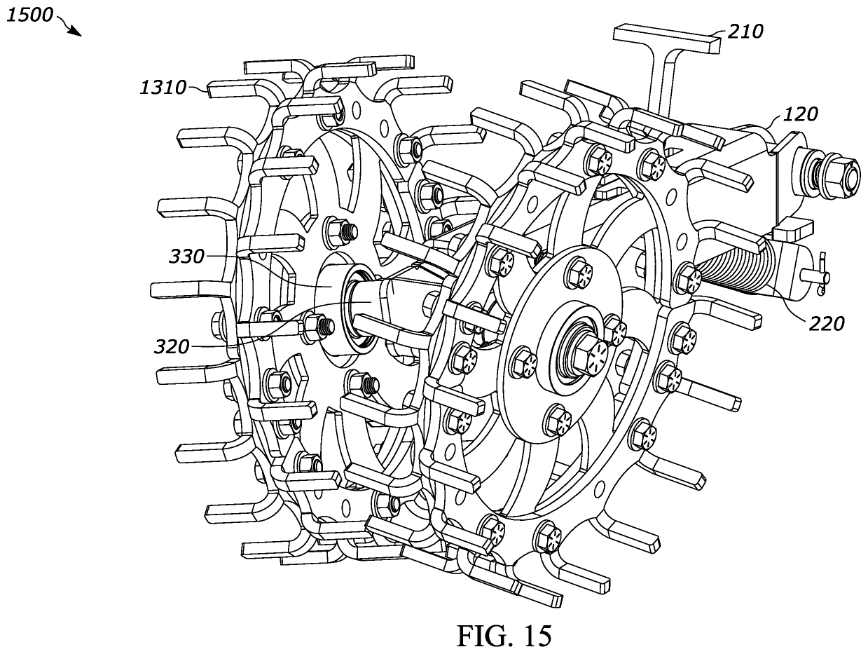

Referring now to FIG. 15, a full assembly view 1500, illustrates mirrored and offset 90 degree conditioning finger elements 1310 as shown in FIGS. 13 and 14 as attached to a strip-till unit. View 1500 shows pivoting arm 120, spring tension adjustment 210 and spring 220 to illustrate how wheel assembly 1500 attaches to axle 320 and hub 330.

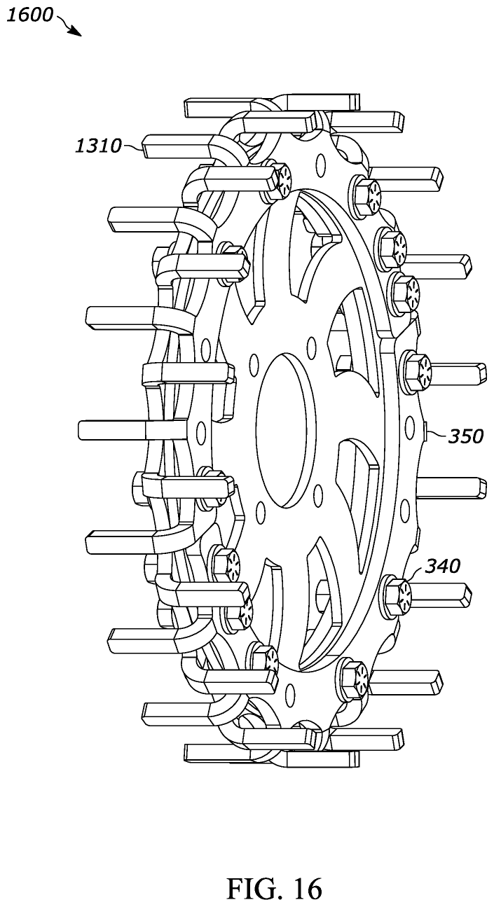

FIG. 16 illustrates a wheel 1600 with two attachment plates with the same conditioning finger elements 1310 with the attachment plates in a flipped configuration as compared to FIGS. 13, 14 and 15. Instead of being a mirrored configuration, swapping each plate enables an interlaced configuration of conditioning finger elements 1310 appropriate for different soil conditioning requirements. For example, if a smaller footprint is required from a stip-till or the like.

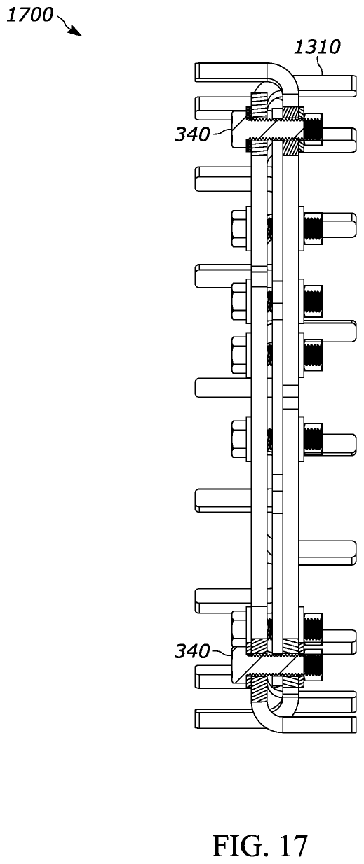

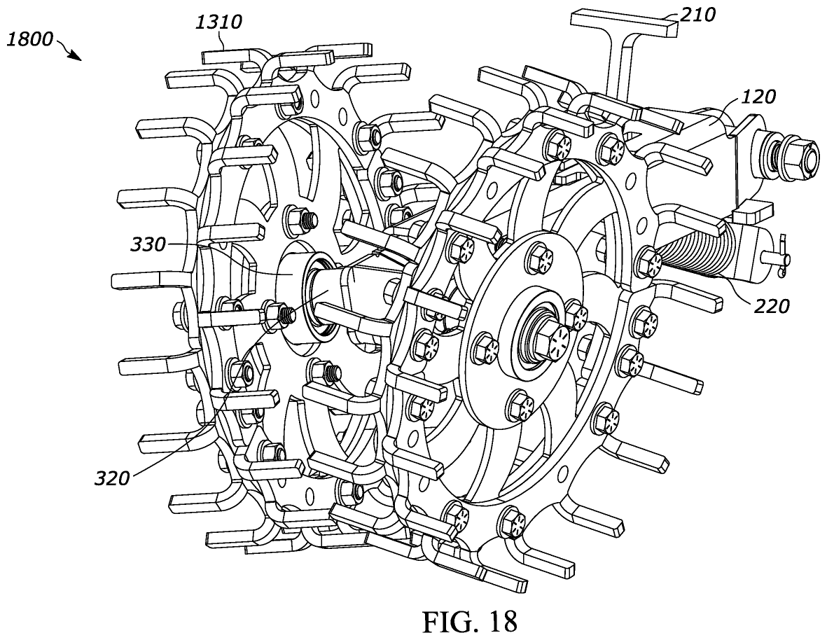

FIG. 17 illustrates a side view 1700 of the same configuration as shown in FIG. 16 to illustrate bolts 340 and conditioning finger elements 1310. As compared to FIG. 14, it is apparent that the same attachment plates are reconfigured to yield a smaller footprint for soil conditioning. Referring to FIG. 18, a conditioning wheel assembly 1800 illustrates the same configuration as shown in FIG. 17 to show pivoting arm 120, spring tension adjustment 210 and spring 220 to illustrate how wheel assembly 1800 attaches to axle 320 and hub 330. The conditioning finger elements of FIGS. 16, 17 and 18 each horizontally intersect the vertical plane of the wheel in an angle to which the finger elements are swept back at 90 degrees and bend towards the vertical plane at 90 degrees such that the configuration resembles finger elements of a hand when interlocked. The sectional finger elements of the sides are offset by ½ the distance between the finger elements of a section.

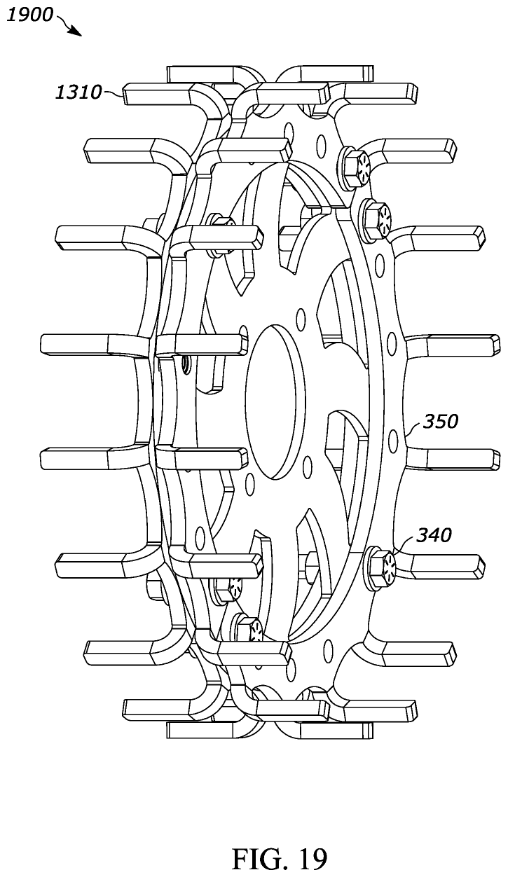

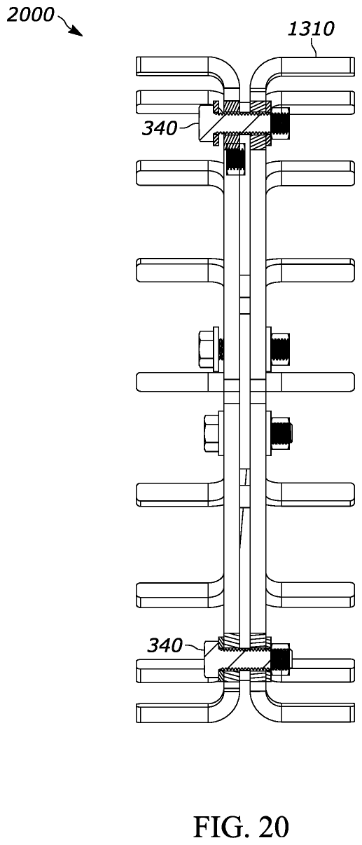

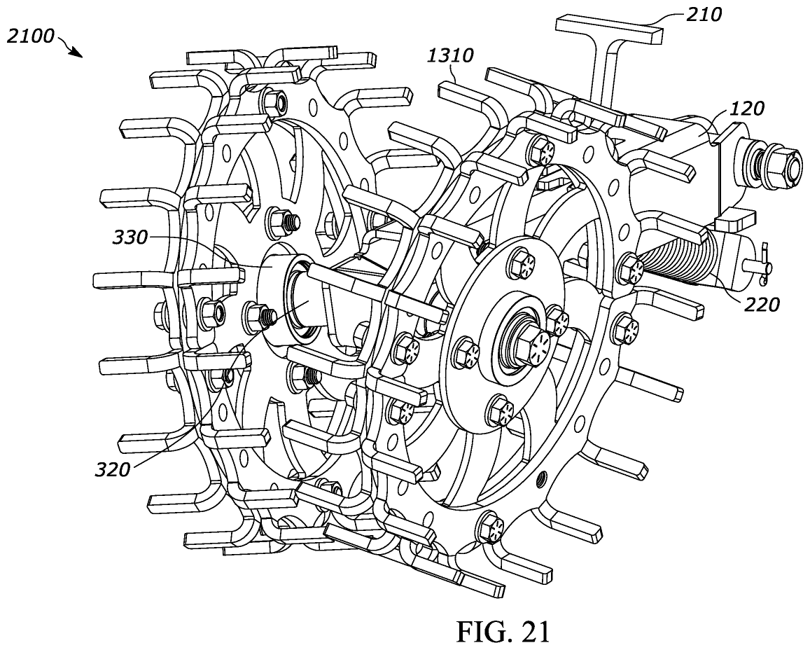

Referring now to FIG. 19, view 1900 illustrates a conditioning wheel with the same attachment plates flipped and rotated to provide a mirrored and 90 degree bent configuration for conditioning finger elements 1310. FIG. 19 further illustrates that the rotation may be accomplished using bolts 340 positioned in different mounting holes 350 to efficiently alter the configuration. Thus, when soil conditions dictate a wider footprint, the same attachment plates may accomplish soil conditioning. FIG. 20 illustrates view 2000 to show a side view of bolts 340 and conditioning finger elements 310 for the same configuration shown in FIG. 19. FIG. 21 illustrates a full assembly view 2100 of the configuration illustrated in FIGS. 19 and 20 to illustrate pivoting arm 120, spring tension adjustment 210 and spring 220 and how wheel assembly 2100 attaches to axle 320 and hub 330.

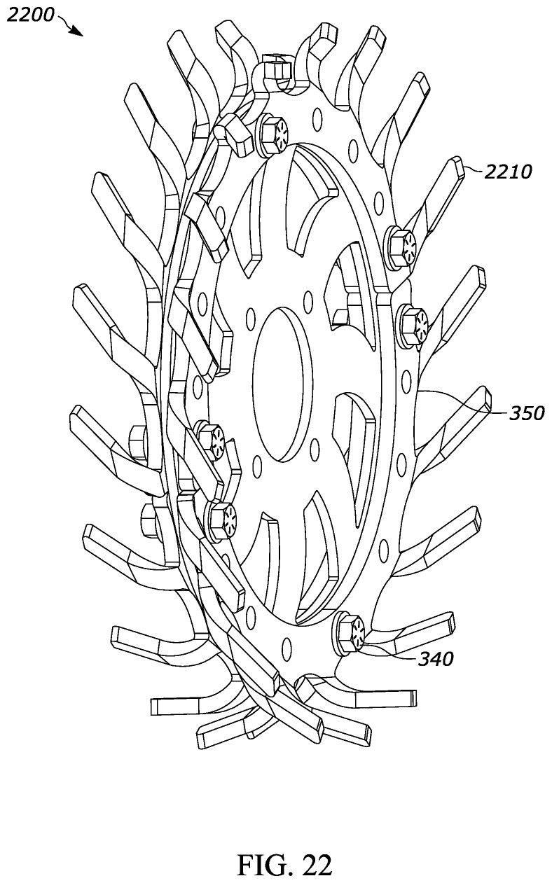

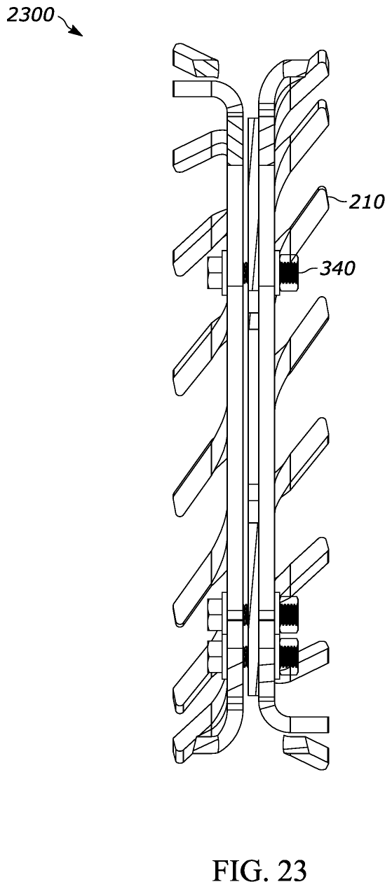

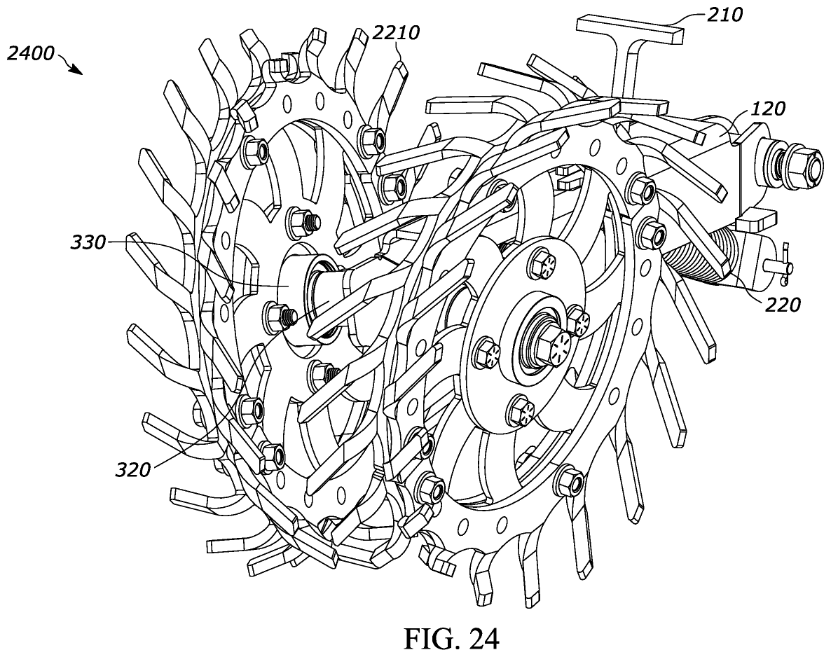

Referring to FIG. 22, another embodiment is directed to a wheel 2200 with attachment plates having conditioning finger elements 2210 that are twisted and bent less than 90 degrees from the vertical plane of the wheel and aligned so that each finger is an extension of a finger of another attachment plate in a same line. Such a configuration may be beneficial for soil conditions requiring maximum displacement of clods and the like. FIG. 23 illustrates the same conditioning finger elements 2210 so that it is apparent that the footprint of the wheel results in elongated, slanted soil conditioning appropriate for different soil conditions. FIG. 24 illustrates a full assembly view 2400 with the same configuration as shown in FIGS. 22 and 23 with the aligned conditioning finger elements 2210. FIG. 24 illustrates pivoting arm 120, spring tension adjustment 210 and spring 220 to illustrate how wheel assembly 2400 attaches to axle 320 and hub 330.

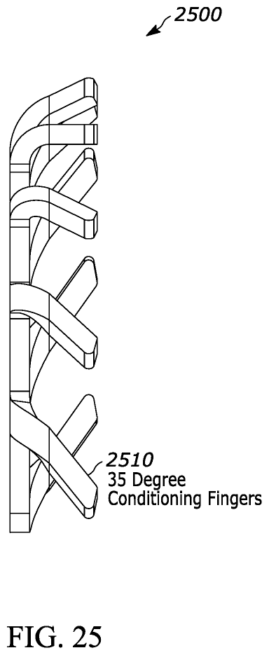

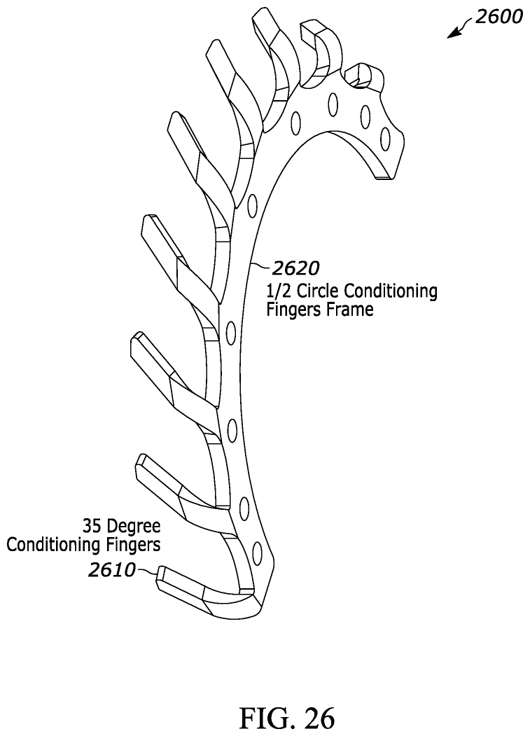

Referring now to FIG. 25, attachment plate 2500 is illustrated to show a partial attachment plate that may be used in combination with one or more additional attachment plates to cover an entire circumference of a wheel. As shown in FIG. 25, conditioning finger elements 2510 may be bent 35 degrees from the vertical plane of the wheel. FIG. 26 illustrates view 2600 of the same conditioning finger elements 2510 to show a ½ circle conditioning finger elements frame. As one of skill in the art will appreciate, a wheel may have two ½ circle conditioning finger elements frames with different types of conditioning finger elements to enable more robust soil conditioning as a soil requires. For example, at different times of the year, different soil conditions may require different types of conditioning finger elements to properly prepare a soil for planting and the like.

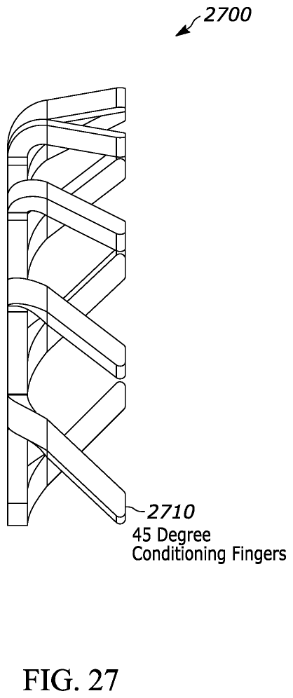

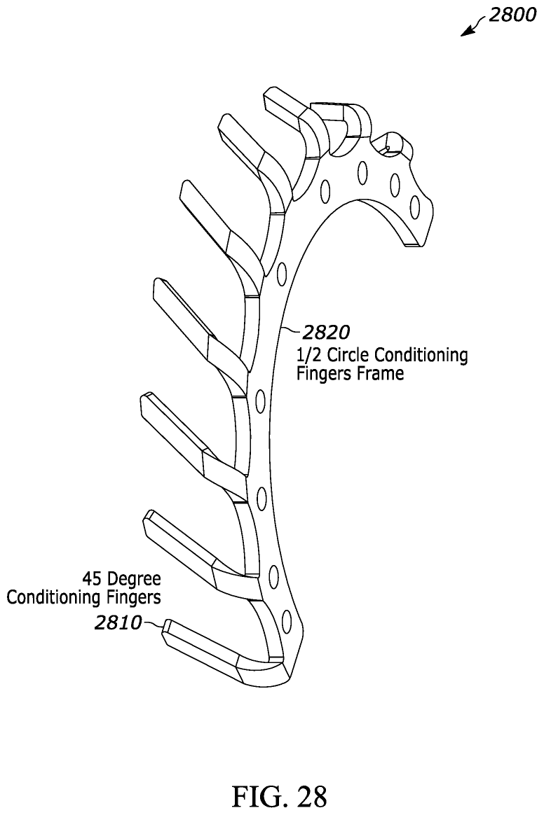

FIG. 27 illustrates another embodiment with 45-degree conditioning finger elements 2710 which may be on a full 360 degree attachment plate or a partial attachment plate. FIG. 28 illustrates view 2800 that includes the same 45-degree conditioning finger elements 2710 on a ½ circle conditioning finger elements frame 2820. For example, depending on soil conditions, one configuration may be a full wheel with both 35 degree and 45-degree conditioning finger elements on the same wheel. The reconfiguration possibilities may further include any of the conditioning finger elements described herein as necessitated by soil conditions, time of the year and the like.

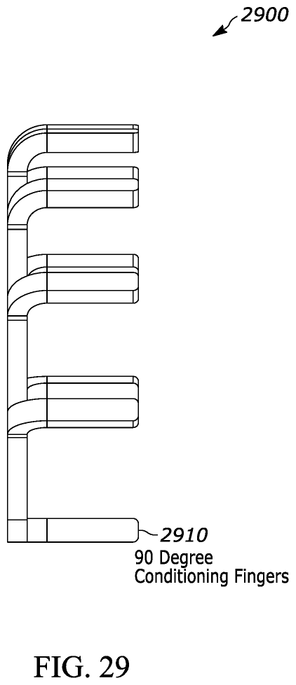

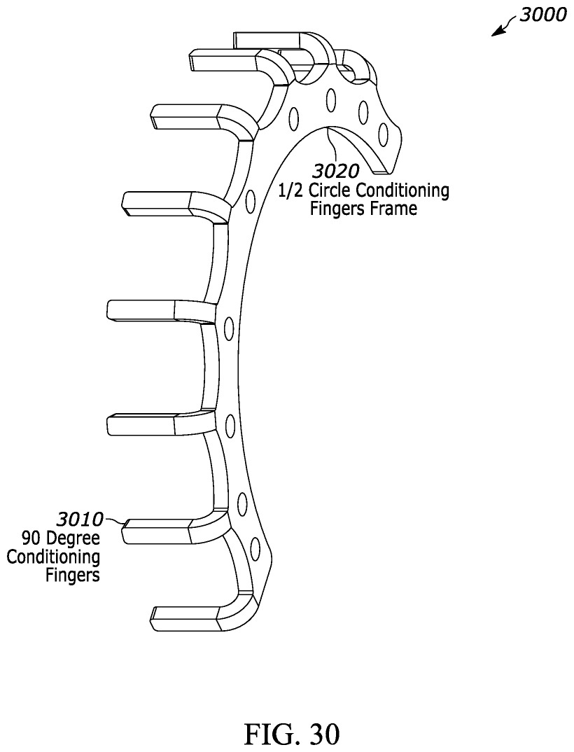

FIG. 29 illustrates a partial attachment frame with 90 degree bent conditioning finger with respect to the vertical plane of the wheel 2910. FIG. 30 illustrates perspective view 3000 and the same 90 degree bent conditioning finger elements 2910 as shown in FIG. 29 in a ½ circle conditioning finger elements frame 3020.

In each embodiment, the center portion of the wheel to which attachment plates attach may have a diameter made of metal or other durable material which maintains its shape and structure being from ¼ inches thick to ½ inches thick with a diameter of 10 inches to 14 inches in with equidistantly spaced holes to which the attachment plates described above may attach. Thus, individual sections, such as ½ circle, or full circle plates of ground engaging finger elements with matching equidistant holes on the attachment plate of the sections may be attached by bolts or other removable attachment means to the outer circumference of both sides of the wheel.

Thus, a plurality of finger conditioning attachment plate sections totaling 360 degrees of arc match the circumference of the associated wheel are attached, one for each side of the wheel. As described above, attachment plates may be secured such that ground engaging finger elements oppose each other. Attachment plates may also be secured such that ground engaging finger sections are affixed to the outer circumference of the wheel in a mirror configuration or in an interlaced configuration. The ground engaging finger elements may also horizontally intersect the vertical plane of the wheel in such an interlaced configuration in a compound angle in which the finger elements are swept back at 35 degrees and bent away from the vertical plane up to 90 degrees. In another configuration, finger elements are swept back at 35 degrees and bend away from the vertical plane at 90 degrees on one side of the wheel and sweep forward at 35 degrees and bend away from the vertical plane at 90 degrees on the opposite side of the wheel. In other embodiments, the finger elements may horizontally intersect the vertical plane of the wheel in a compound angle to which the finger elements are swept back at 45 degrees and bent away from the vertical plane up to 90 degrees.

As one of skill in the art will appreciate with the benefit of this disclosure, further configurations are possible and within the scope of the present disclosure, such as by rotating different attachment plates ½ the distance between the finger elements of a section, flipping an attachment plate such that attachment plates either face each other with respect to the finger elements or oppose each other with respect to the finger elements or to flip one attachment plate. Aside from rotating and flipping attachment plates, the finger elements themselves may be different on each attachment plate to achieve further configurations. For example, some attachment plates may be swept back 35 degrees, 45 degrees, or be 90 degrees bent. Further, the finger elements themselves, as shown FIGS. 1-30 may have a square cross section individually and may be twisted to achieve the different angles described herein. The square bar design along with the formed structure of the sections with the finger elements enables soil conditioning in multiple configurations with the same segments thereby creating a customizable seedbed ready strip.

Another embodiment is directed to a method for soil conditioning including providing at least two wheels having an outer circumference including a plurality of equidistantly spaced openings for engagement. For example, wheels 360 and 390 shown in FIGS. 3B-3D are connected to a hub and have mounting holes. The method continues with attaching at least two attachment plates having a circumference matching the outer circumference to each wheel to the outer circumference via a plurality of attachment means configured on each attachment plate. For example, as shown in FIG. 3A, attachment plates may be attached to mounting holes 350 using bolts 340 to form conditioning wheel assembly 102. The method continues with aligning each attachment plate with the plurality of equidistantly spaced openings, wherein each attachment plate includes a plurality of ground-engaging finger elements coupled to each attachment plate over a 360-degree arc, the plurality of ground-engaging finger elements extending outwardly from the wheel to enable ground engagement. For example, as shown FIG. 3A coupling the at least two wheels to a pivoting arm and a chassis of a strip-till unit to form a ground driven soil conditioner. In accordance with embodiments, the ground-engaging finger elements may be formed with the attachment plates to provide angled fingers, such as complex angles, 35 degree, 45 degree or 90 degree angles or the like in accordance with soil conditioning needs.

One embodiment of the method includes attaching one or more delivery tubes to the chassis to dispense surface applied herbicides, seed and fertilizer. For example, as shown in FIG. 1, shank 130 is coupled to chassis 150 for delivery of fertilizer, seed, and other products. As will be appreciated by those of skill in the art with the benefit of the present disclosure, the choice of attachment plate and configuration will be a function of the product being dispensed, the time of year, and the quality of the soil to be conditioned among other considerations.

This disclosure may be embodied in many different forms and should not be construed as limited to the example embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the above-described example embodiments but should be defined only in accordance with the following claims and their equivalents. The description below has been presented for the purposes of illustration and is not intended to be exhaustive or to be limited to the precise form disclosed. It should be understood that alternative implementations may be used in any combination desired to form additional hybrid implementations of the present disclosure. For example, any of the functionality described with respect to a particular device or component may be performed by another device or component. Furthermore, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments.

It should also be understood that the word “example” as used herein is intended to be non-exclusionary and non-limiting in nature. Furthermore, certain words and phrases that are used herein should be interpreted as referring to various objects and actions that are generally understood in various forms and equivalencies by persons of ordinary skill in the art.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described example embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments, as will be understood by those of ordinary skill in the art with the benefit of the present disclosure.

That which is claimed is:

1. A soil conditioning apparatus comprising:
a wheel having an outer circumference including a plurality of equidistantly spaced openings for engagement;
at least two attachment plates coupled to the outer circumference via a plurality of attachment means configured on each attachment plate to align with the plurality of equidistantly spaced openings; and
a plurality of ground-engaging finger elements having a square cross section coupled to each attachment plate, the plurality of ground-engaging finger elements directed outwardly from the wheel to enable ground engagement.

2. The soil conditioning apparatus of claim 1 wherein the plurality of ground-engaging finger elements are formed with each attachment plate.

3. The soil conditioning apparatus of claim 1 wherein each of the plurality of finger elements extend horizontally from a vertical plane of the wheel from between 0 to 10 degrees of incline.

4. The soil conditioning apparatus of claim 1 wherein each of the plurality of ground-engaging finger elements have a swept angle of 30 to 90 degrees from a vertical plane of the wheel.

5. The soil conditioning apparatus of claim 1 wherein each of the plurality of ground-engaging finger elements extend beyond the outer circumference forming a larger circumference than the wheel.

6. The soil conditioning apparatus of claim 1 wherein the plurality of ground-engaging finger elements is reconfigurable to enable a plurality of orientations by altering the relationship between the at least two attachment plates with respect to the wheel through clockwise or counterclockwise rotation.

7. The soil conditioning apparatus of claim 1 wherein the plurality of ground-engaging finger elements is reconfigurable to enable a plurality of orientations by altering the relationship between the at least two attachment plates with respect to the wheel through reversing one or more of the at least two attachment plates with respect to the wheel.

8. The soil conditioning apparatus of claim 1 wherein the plurality of ground-engaging finger elements is interlaced.

9. The soil conditioning apparatus of claim 1 wherein the plurality of ground-engaging finger elements is installed as mirror image via the at least two attachment plates.

10. The soil conditioning apparatus of claim 1 wherein the said plurality of ground-engaging finger elements is installed in an offset orientation via rotation of the at least one of the at least two attachment plates with respect to the wheel.

11. The soil conditioning apparatus of claim 1 wherein the plurality of ground-engaging finger elements is installed in aligned orientation via the at least two attachment plates.

12. The soil conditioning apparatus of claim 1 further comprising:
at least a second wheel coupled to the wheel via a hub and axle, the second wheel including a second wheel outer circumference with a plurality of equidistantly spaced openings for engagement of at least two second wheel attachment plates the second wheel outer circumference via a plurality of attachment means configured on each second wheel attachment plate to align with the plurality of equidistantly spaced openings on the second wheel; and
a plurality of second wheel ground-engaging finger elements having a square cross section coupled to each second wheel attachment plate, the plurality of ground-engaging finger elements directed outwardly from the second wheel to enable ground engagement, wherein the wheel and the second wheel form a conditioner wheel assembly, the hub and axle formed to engage each of the wheel and the second wheel to form an acute angle with respect to soil.

13. A method for soil conditioning comprising:
providing at least two wheels having an outer circumference including a plurality of equidistantly spaced openings for engagement;
attaching at least two attachment plates having a circumference matching the outer circumference to each wheel to the outer circumference via a plurality of attachment means configured on each attachment plate;
aligning each attachment plate with the plurality of equidistantly spaced openings, wherein each attachment plate includes a plurality of ground-engaging finger elements coupled to each attachment plate over a 360-degree arc, the plurality of ground-engaging finger elements extending outwardly from the wheel to enable ground engagement; and
coupling the at least two wheels to a pivoting arm and a chassis of a strip-till unit to form a ground driven soil conditioner.

14. The method of claim 13 further comprising:
attaching one or more delivery tubes to the chassis to dispense surface applied herbicides, seed and fertilizer.

15. A strip till finishing system comprising:
a chassis;
a plurality of blades coupled to the chassis, the plurality of blades including at least a center cutter, and a pair of containment blades;
a pair of wheels coupled to the chassis via an arm appendage, each wheel of the pair of wheels having an outer circumference including a plurality of equidistantly spaced openings for engagement;
at least two attachment plates coupled to each of the pair of wheels, each attachment plate having a circumference matching the outer circumference, each attachment plate coupled to the outer circumferences via a plurality of attachment means configured on each attachment plate to align with the plurality of equidistantly spaced openings;
a plurality of ground-engaging finger elements coupled to each attachment plate over a 360 degree arc, the plurality of ground-engaging finger elements directed outwardly from each wheel to enable ground engagement;
a spring coupled to the arm appendage at a compound angle of orientation to a strip of ground, the spring providing a transfer of forward momentum for applying an energy of force towards soil clods and underlying disturbed soil to alter one or more of air pockets, clods, and surface soil, and to move loose soil generally towards a center of the strip of ground.

16. The strip till finishing system in claim 15 wherein the pair of wheels enable application of surface applied herbicides.

17. The strip till finishing system in claim 15 wherein the pair of wheels enable application of surface applied herbicides.

18. The strip till finishing system in claim 15 wherein the pair of wheels enable application of small seed.

19. The strip till finishing system of claim 15 wherein each wheel of the pair of wheels has one, two, four or six attachment plates to cover a 360 degree arc surrounding the perimeter of each wheel.

20. The strip till finishing system of claim 19 wherein each of the one, two, four or six attachment plates are reconfigurable by one or more of reversing each plate, offsetting each plate, rotating each plate, and altering each plate to provide different angulation with respect to the ground engaging finger elements.
